(19) United States
(12) Patent Application Publication
(10) Pub. No.: US 2012/0064898 A1
(43) Pub. Date: Mar. 15, 2012

(54) METHOD AND DEVICE FOR SUPPORTING MULTICAST BROADCAST SERVICE

(75) Inventor: Seong Won Oh, Gyeonggi-do (KR)

(73) Assignee: SEAH NETWORKS CO., LTD, Seoul (KR)

(21) Appl. No.: 13/321,550

(22) PCT Filed: May 20, 2010
(86) PCT No.: PCT/KR10/03215

§ 371 Date: Nov. 20, 2011

(30) Foreign Application Priority Data
May 21, 2009 (KR) 10-2009-0044412

(51) Int. Cl. H04W 36/00

(52) U.S. Cl. 455/437

(57) ABSTRACT

Disclosed are a method and device for supporting Multicast Broadcast Service (MBS). The device for supporting MBS includes a ranging determiner, an MBS determiner, and a message generator. The ranging determiner determines an action state of a mobile station according to a ranging request of the mobile station. The MBS determiner determines whether the mobile station has an MBS flow. The message generator generates a ranging request message on the basis of the action state and MBS flow. When the mobile station has the MBS flow, the message generator adds an MBS indication bit, representing “the mobile station is an MBS mobile station”, into a ranging purpose indication TLV of the ranging request message.

### TECHNICAL FIELD

The present invention relates to a broadband wireless communication system, and more particularly, to a method and device for supporting Multicast Broadcast Service (MBS).

### BACKGROUND ART

A broadband wireless communication system based on Institute of Electrical and Electronics Engineers (IEEE) 802.16d/e or WiMAX standard transmits much data for a short time because having a broad frequency bandwidth and enables all users to share and efficiently use a channel, thereby attracting much attraction as a next generation communication system.

The broadband wireless communication system based on IEEE 802.16D/E or WiMAX standard supports MBS service that provides the same contents to a plurality of users (mobile stations).

Moreover, by performing handover when a mobile station moves from a cell area of a serving base station (which is currently providing service) to a cell area of another base station, the broadband wireless communication system prevents the interruption of the service provided to the mobile station, in which case a procedure for supporting MBS as well as ranging according to handover is required to be performed for the mobile station using the MBS.

However, in the related art, an MBS mobile station is not considered in ranging according to handover. Therefore, a scanning procedure for the MBS mobile station is required to be separately performed after ranging, and consequently, a handover procedure (handover between base stations, the change of an MBS zone) for the MBS mobile station is extended, and a target base station tracks MBS mobile stations, which are respectively located in its own cell and cells adjacent thereto, to have all information on the MBS mobile stations necessarily.

Therefore, by performing a separate procedure for tracking MBS mobile stations, a procedure for supporting MBS is complicated, and load is applied to a network due to the collection and management of information on the MBS mobile stations.

Moreover, the related art cannot propose a ranging method for a mobile station that enables the change of an MBS zone in ranging according to handover. Due to this reason, the provision of MBS to a mobile station is delayed in ranging according to handover, and when the MBS zone is not changed, it is difficult to provide the MBS.

Moreover, the related art cannot provide an MBS supporting method for an MBS mobile station when network re-entry is performed according to the change from an idle mode to an active mode.

Moreover, the related art cannot provide an MBS supporting method for an MBS mobile station when location update is performed according to the change of a paging group of an idle-mode mobile station.

Moreover, a broadband wireless communication system determines whether to support service for a mobile station that has requested ranging through Call Admission Control and Load Control (CACLC), but in the related art, an MBS mobile station is not considered in performing CACLC.

### DISCLOSURE

### Technical Problem

Accordingly, the present invention is directed to provide an MBS supporting method and device that substantially obviate one or more problems due to limitations and disadvantages of the related art.

An aspect of the present invention is directed to provide an MBS supporting method and device for an MBS mobile station in ranging according to handover, network re-entry, or location update.

Another aspect of the present invention is directed to provide an MBS supporting method and device for an MBS mobile station when network re-entry is performed according to the change from an idle mode to an active mode.

Another aspect of the present invention is directed to provide an MBS supporting method and device for an MBS mobile station when location update is performed according to the change of a paging group of an idle-mode mobile station.

Another aspect of the present invention is directed to provide a ranging request (RNG-REQ) message generating method for supporting MBS.

Another aspect of the present invention is directed to provide an MBS supporting method and device, which can reduce the consumption of a wireless resource due to a ranging procedure and ranging performance of an MBS mobile station.

Another aspect of the present invention is directed to provide an MBS supporting method and device, which enable the performance of CACLC in consideration of an MBS mobile station.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these and other advantages and in accordance with the purpose of the invention, as embodied and broadly described herein, there is provided an MBS supporting apparatus including: a ranging determiner determining an action state of a mobile station according to a ranging request of the mobile station; an MBS determiner determining whether the mobile station has an MBS flow; and a message generator generating a ranging request message on the basis of the action state and MBS flow, wherein when the mobile station has the MBS flow, the message generator adds an MBS indication bit, representing “the mobile station is an MBS mobile station”, into a ranging purpose indication TLV of the ranging request message.

In another aspect of the present invention, there is provided an MBS supporting method including: determining an action state of a mobile station, and determining whether the mobile station has an MBS flow, when ranging is requested; generating a ranging request message when the mobile station is determined as having the MBS flow, the ranging request message including: the action state of the mobile station; and an MBS indication bit representing “the mobile station is an MBS mobile station; and transmitting the ranging request message to a base station.

It is to be understood that both the foregoing general description and the following detailed description of the present invention are exemplary and explanatory and are intended to provide further explanation of the invention as claimed.

### Advantageous Effects

The present invention according to embodiments can provide an MBS supporting method and device for an MBS mobile station in ranging according to handover, network re-entry, or location update.

The present invention according to embodiments can provide a ranging request (RNG-REQ) message generating method for supporting MBS.

An MBS supporting method and device according to embodiments of the present invention can reduce the consumption of a wireless resource due to a ranging procedure and ranging performance of an MBS mobile station.

An MBS supporting method and device according to embodiments of the present invention can support the performance of CACLC for an MBS mobile station.

An MBS supporting method and device according to embodiments of the present invention can prevent the delay or interruption of MBS provided to a mobile station that enables handover or the change of an MBS zone.

An MBS supporting method and device according to embodiments of the present invention can support MBS for an MBS mobile station when network re-entry is performed according to the change from an idle mode to an active mode.

An MBS supporting method and device according to embodiments of the present invention can support MBS for an MBS mobile station when location update is performed according to the change of a paging group of an idle-mode mobile station.

### DESCRIPTION OF DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a diagram schematically illustrating a configuration of a broadband wireless communication system;

FIG. 2 is a diagram illustrating an MBS supporting apparatus which is applied to a mobile station, according to an embodiment of the present invention;

FIG. 3 is a diagram showing a ranging purpose indication of a ranging request (RNG-REQ) message for supporting MBS, according to an embodiment of the present invention;

FIG. 4 is a diagram illustrating an MBS supporting apparatus which is applied to a base station, according to an embodiment of the present invention; and

FIG. 5 is a diagram illustrating an MBS supporting method according to an embodiment of the present invention.

### MODE FOR INVENTION

Reference will now be made in detail to the exemplary embodiments of the present invention, examples of which are illustrated in the accompanying drawings. Wherever possible, the same reference numbers will be used throughout the drawings to refer to the same or like parts.

Hereinafter, a method and device for supporting Multicast Broadcast Service (MBS) and a ranging request (RNG-REQ) message for ranging of a mobile station, according to an embodiment of the present invention, will be described in detail with reference to the accompanying drawings.

In the following description of the present invention that will be made with reference to the drawings, it is assumed that a mobile station normally enters a network by performing: a network topology advertisement procedure that notifies all mobile stations (which are located in a cell) of information regarding a base station (BS); a neighbor base station scanning procedure that measures the channel qualities of neighbor base stations on the basis of the information; and an association procedure that optionally adjusts a time difference value for synchronization and power offset values of the mobile station and base station, when an initial network entry is performed.

Moreover, it is assumed that a mobile station receives information (NBR BS List) regarding neighbor base stations and a target base station is determined from among the neighbor base stations, in a handover procedure that is performed when the mobile station moves from a cell area of a serving base station (which is currently providing service) to a cell area of a base station adjacent thereto.

In the following description of the present invention, an initial network entry procedure, a handover-related procedure, a message that is transmitted and received between a mobile station and a base station in the initial network entry procedure and handover procedure, a network re-entry procedure, a location update procedure that is performed according to the change of a paging group, and MBS-related matters are not described in detail. However, such procedures and matters may be referenced from the IEEE 802.16 standard document and the WiMAX forum Network (Working Group NWG) standard document that are technological standards of a broadband wireless access system.

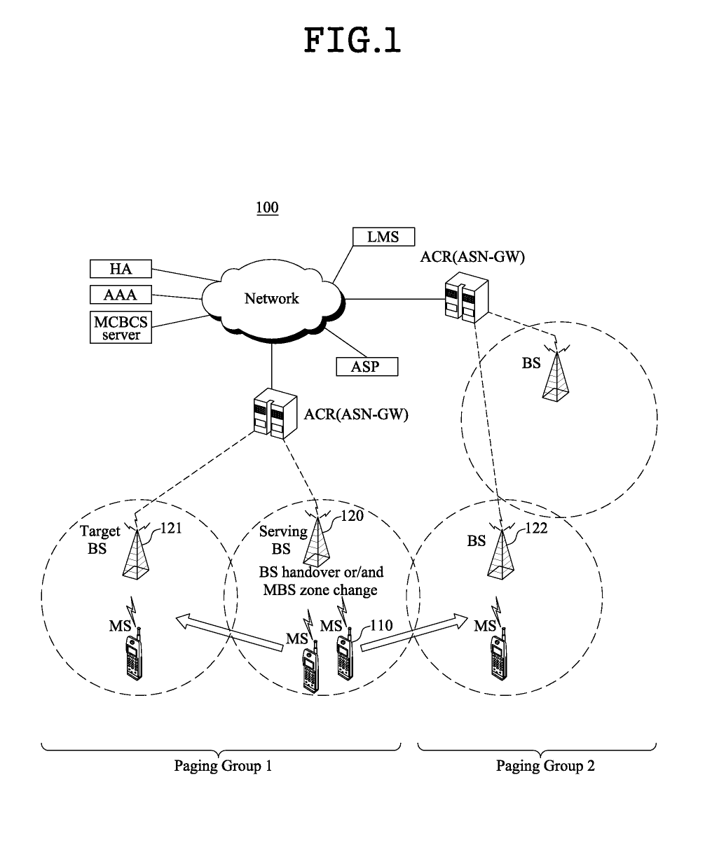

FIG. 1 is a diagram schematically illustrating a configuration of a broadband wireless communication system.

Referring to FIG. 1, a broadband wireless communication system 100 includes a plurality of base stations (RAS) 120 to 122 that manages a cell of a certain area, a plurality of mobile stations (MS) 110 that transmit/receive data from/to the base stations 120 to 122, a plurality of control stations (ACR, ASN-GW) that control the base stations 120 to 122 by paging group unit, and a network for accessing the control stations.

Moreover, the broadband wireless communication system 100 includes a home agent that accesses the network to allocates an Internet Protocol (IP) address, a user authentication server (AAA: Authentication Authorization Accounting) that provides a user's authentication information and charging information, a multicast broadcast service (MCBCS) server for supporting MBS, a location management system (LMS) that provides and manages the location information of a mobile station, and an application service provider (ASP) that provides MBS contents to the mobile station.

Herein, data transmission and reception between a mobile station and a base station is performed by an Orthogonal Frequency Division Multiplexing (OFDM) scheme or an Orthogonal Frequency Division Multiple Access (OFDMA) scheme, and mobility of the mobile station is supported by a multi-cell structure.

The base stations 120 to 122 manage and control wireless resources, and also support a downlink multicast function, a handover function, and an idle mode function for reducing the power consumption of the mobile station 110.

An interface for a plurality of call processing signals for the initial access, authentication, authorization, verification, location registration, service flow management, handover, and idle mode of each mobile station is prepared between the base stations 120 to 122. Also, an interface for a plurality of call processing signals for the map management of an adjacent control station and handover between the control stations is prepared between the base stations 120 to 122 and each control station.

Each control station (ACR, ASN-GW) is a network infra system for providing broadband wireless communication service, and accesses the base stations 120 to 122 to connect and manage the base stations 120 to 122. Also, each control station performs a data packet routing function, an authentication requesting function, a function that collects and transmits charging data, and a function that collects and transmits information regarding operation and maintenance.

The home agent (HA) accessing the network is an element for providing mobile IP service. The home agent allocates an IP address to the mobile station 110 according to the mobile IP request of a control station, and transmits/receives packet data to/from the control station.

The user authentication server (AAA) provides information for user authentication, authorization authentication, and charging according to the requests of the control station and home agent.

The location management system (LMS) denotes software for managing the state information and location information of a subscriber, and hardware connected to the software. The location management system (LMS) stores and manages subscriber state information, mobile station location information, service information, etc.

The broadband wireless communication system 100 supports mobility of the mobile station 110, and thus, when the mobile station 110 moves and enters from a cell area of the serving base station 120 (which is currently providing service to the mobile station 110) into a cell area of the base station 121 adjacent thereto, by performing a ranging procedure according to handover, the broadband wireless communication system 100 maintains service provided to the mobile station 110.

Herein, in ranging according to handover, the mobile station 110 transmits a ranging request (RNG-REQ) message to the target base station 121 for associating in a cell of the target base station 121, and the target base station 121 transmits a ranging response (RNG-RSP) message to the mobile station 110 to set a frequency and time correction value in response to the ranging request (RNG-REQ) message and thus associates the mobile station 110 in its own cell.

The transmission of the ranging request (RNG-REQ) message from a mobile station may be performed in the following three cases, in addition to an initial network entry procedure where the mobile station is powered on and enters the network initially.

First, the ranging request (RNG-REQ) message may be transmitted when the mobile station performs handover.

Second, the ranging request (RNG-REQ) message may be transmitted when a network re-entry (network re-entry form idle mode) is performed according to the change from an idle mode for reducing the power consumption of the mobile station to an active mode.

Third, the ranging request (RNG-REQ) message may be transmitted for location update (location update during idle mode) when a paging group is changed by moving of the idle-mode mobile station.

To provide a description on the first handover case, the broadband wireless communication system 100 prevent prevents the interruption of service provided to the mobile station 110 by performing handover when the mobile station 110 moves from a cell area of the serving base station 120 (which is currently providing the service) to a cell area of another base station.

Herewith, the broadband wireless communication system 100 supports MBS that provides the same contents to a plurality of users over one link, in which case an MBS mobile station is required to be considered upon handover for providing the MBS to a mobile station having an MBS flow.

Subsequently, as in the second case, the MBS is required to be considered when the mobile station has the MBS flow, in the network re-entry procedure (network re-entry form idle mode) that is performed according to the change from the idle mode to the active mode.

In the third case, the MBS is required to be considered when the mobile station has the MBS flow, in the location update procedure (location update during idle mode) that is performed according to the change of the paging group of the idle-mode mobile station.

As described above, when the MBS is considered in the ranging procedure that is performed according to handover, the change from the idle mode to the active mode, or location update, a ranging procedure and a procedure for providing MBS can be simplified.

For this end, the mobile station 110 necessarily generates the ranging request (RNG-REQ) message in consideration of MBS and an action state thereof such as handover, the change from the idle mode to the active mode, and location update, and transmits the ranging request (RNG-REQ) message to a corresponding base station.

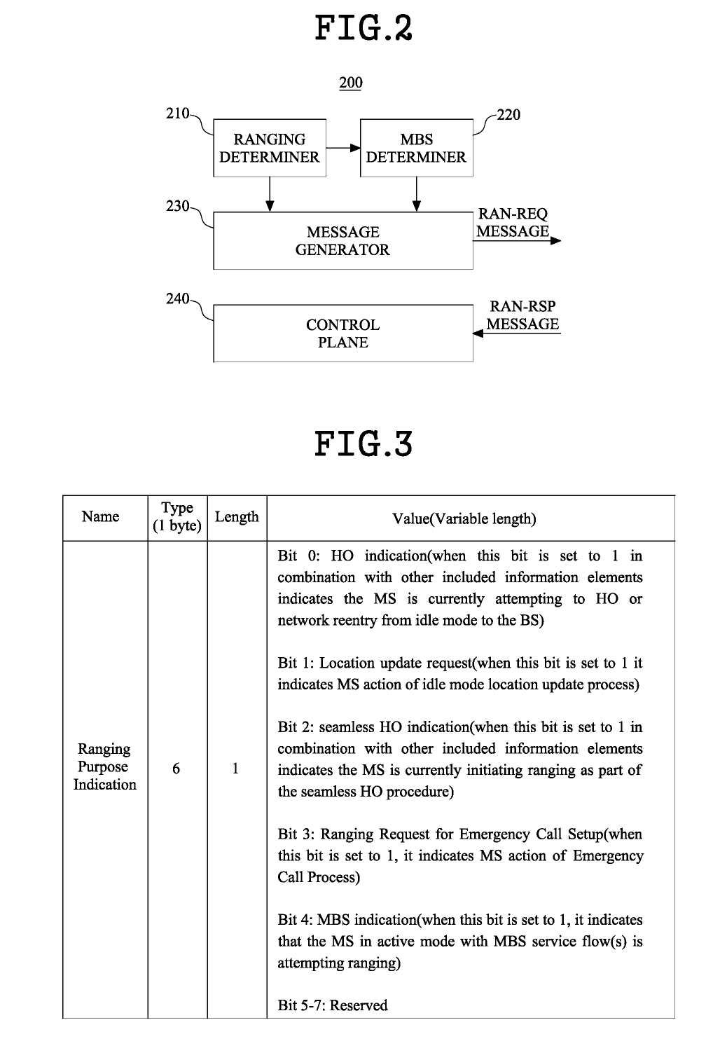

For this end, the mobile station 110 includes an MBS supporting apparatus 200 of FIG. 2 according to an embodiment of the present invention.

Referring to FIG. 2, the MBS supporting apparatus 200 applied to the mobile station 110, according to an embodiment of the present invention, includes a ranging determiner 210, an MBS determiner 220, a message generator 230, and a control plane 240.

The ranging determiner 210 determines whether the mobile station 110 requires ranging, and when the ranging is required, the ranging determiner 210 checks an action state of the mobile station 110. Specifically, the ranging determiner 210 determines whether the ranging is required according to the performance of handover, the change from the idle mode to the active mode, or the change of a paging group in the idle mode. Subsequently, the ranging determiner 210 supplies the determined result for the action state of the mobile station 110 to the message generator 230.

When the generation of the ranging request (RNG-REQ) message is required according to the ranging, the MBS determiner 220 checks whether the mobile station 110 has an MBS flow, and supplies the checked result for the MBS flow to the message generator 230.

The message generator 230 generates the ranging request (RNG-REQ) message on the basis of the determined result (supplied from the ranging determiner 210) for the action state of the mobile station 110 and the checked result (supplied from the MBS determiner 220) for the MBS flow.

Specifically, the message generator 230 generates the ranging request (RNG-REQ) message when the mobile station 110 performs handover or is changed from the idle mode to the active mode or the paging group of the mobile station 110 is changed in the idle mode. Herein, the ranging request (RNG-REQ) message may be generated in a Media Access Control (MAC) layer.

Moreover, when the checked result (supplied from the MBS determiner 220) for the MBS flow shows that the mobile station 110 has the MBS flow, the message generator 230 adds an MBS indication bit (representing “the mobile station 110 is an MBS mobile station”) into a ranging purpose indication Type/Length/Value (TLV) included in the ranging request (RNG-REQ) message.

Herein, as shown in FIG. 3, the ranging purpose indication TLV including the MBS indication bit may be generated as an example.

Moreover, the message generator 230 may encode the MBS indication bit and a handover (HO) indication bit or location update request bit into the ranging purpose indication TLV according to the action state of the mobile station 110. Furthermore, according to the action state of the mobile station 110, the message generator 230 may add a serving base station identifier (BSID) and a paging controller ID into the raging request (RNG-REQ) message.

Specifically, when a mobile station having the MBS flow performs handover, the message generator 230 may encode both the MBS indication bit and the handover indication bit. Furthermore, the message generator 230 may add the serving BSID into the raging request (RNG-REQ) message.

When the mobile station having the MBS flow is changed from the idle mode to the active mode, the message generator 230 may encode both the MBS indication bit and the handover indication bit. Furthermore, the message generator 230 may add the paging controller ID into the raging request (RNG-REQ) message.

When a paging group of the mobile station having the MBS flow is changed in the idle mode, the message generator 230 may encode both the MBS indication bit and the location update request bit. Furthermore, the message generator 230 may add the paging controller ID into the raging request (RNG-REQ) message, for performing location update for initial location update and MBS zone update.

As described above, when a mobile station intending to perform ranging has the MBS flow, as shown in FIG. 3, the MBS supporting apparatus 200 may add the MBS indication bit into the ranging purpose indication TLV to generate the ranging request (RNG-REQ) message.

Moreover, based on the action state of a mobile station, the message generator 230 may generate the ranging request (RNG-REQ) message so as to include the handover indication bit, paging controller ID, or location update request bit.

The ranging request (RNG-REQ) message generated by the message generator 230 is supplied to a transceiver (not shown) of a mobile station, and the transceiver transmits the ranging request (RNG-REQ) message, supplied from the message generator 230, to a base station through a physical layer.

Referring to FIG. 3, the ranging purpose indication TLV included in the ranging request (RNG-REQ) message may be composed of total 8 bits from bit 0 to bit 7. Herein, 5 bits from bit 0 to bit 4 may be used for handover, network re-entry of a mobile station, location update that is performed according to the change of a paging group of an idle-mode mobile station, emergency call setup, and MBS indication. Furthermore, the other bits from bit 5 to bit 7 may be used as reserved bits that will be used subsequently depending on the case.

Based on each bit of the ranging purpose indication TLV, an embodiment of an action state of a mobile station is shown as follows.

First, the bit 0 represents handover indication. When the bit 0 is encoded as 1, the bit 0 may represent the performance of handover or network re-entry that is performed when a mobile station is changed from the idle mode to the active mode. Herein, when the mobile station performs handover, the serving BSID may be added into the ranging request (RNG-REQ) message. Furthermore, when the mobile station is changed from the idle mode to the active mode, the paging controller ID may be added into the ranging request (RNG-REQ) message.

Subsequently, the bit 1 represents a location update request, and when the bit 1 is encoded as 1, the bit 1 may represent location update that is performed according to the change of a paging group of an idle-mode mobile station.

Herein, when the mobile station performs location update for initial location update and MBS zone update, the paging controller ID may be added into the ranging request (RNG-REQ) message.

The bit 2 represents seamless handover indication, and when the bit 2 is encoded as 1, a seamless handover procedure may be performed such that service is seamlessly provided in handover.

The bit 3 represents a ranging request for emergency call setup, and when the bit 3 is encoded as 1, the mobile station may perform an emergency call setup procedure.

The bit 4 represents MBS indication, and when the bit 4 is encoded as 1, this may represent that a corresponding mobile station is an MBS mobile station having the MBS flow. Specifically, when an active-mode mobile station having a multi base station MBS flow moves and thus a serving base station is changed (i.e., handover), a corresponding mobile station performs ranging according to handover.

When a service BSID is included in the ranging request (RNG-REQ) message and a handover indication bit and MBS indication bit of the ranging purpose indication TLV are encoded as 1, this may represent that an active-mode mobile station having the MB flow tries to perform ranging according to handover.

In a broadband wireless communication system based on IEEE 802.16d/e or WiMAX technical standard, the power consumption of mobile stations is important factor of the system. Therefore, in order to minimize the power consumption of mobile stations, the broadband wireless communication system supports the idle mode and active mode for each base station and mobile station.

In another embodiment of the present invention, when a paging controller ID is included in the ranging request (RNG-REQ) message and a handover indication bit and MBS indication bit of the ranging purpose indication TLV are encoded as 1, this may represent that an idle-mode mobile station having the MB flow tries to perform a network re-entry procedure according to the change of the mobile station from the idle mode to the active mode.

In another embodiment of the present invention, when a paging controller ID is included in the ranging request (RNG-REQ) message and a location update request bit and MBS indication bit of the ranging purpose indication TLV are encoded as 1, this may represent that a corresponding mobile station tries to perform location update according to the change of a paging group of an idle-mode mobile station having the MBS flow.

A mobile station transmits the ranging request (RNG-REQ) message to a base station, and then receives a ranging response (RNG-RSP) message from the base station in response to the ranging request (RNG-REQ) message. The control plane 240 may set a plurality of parameters for applying MBS, on the basis of MBS information included in the ranging response (RNG-RSP) message.

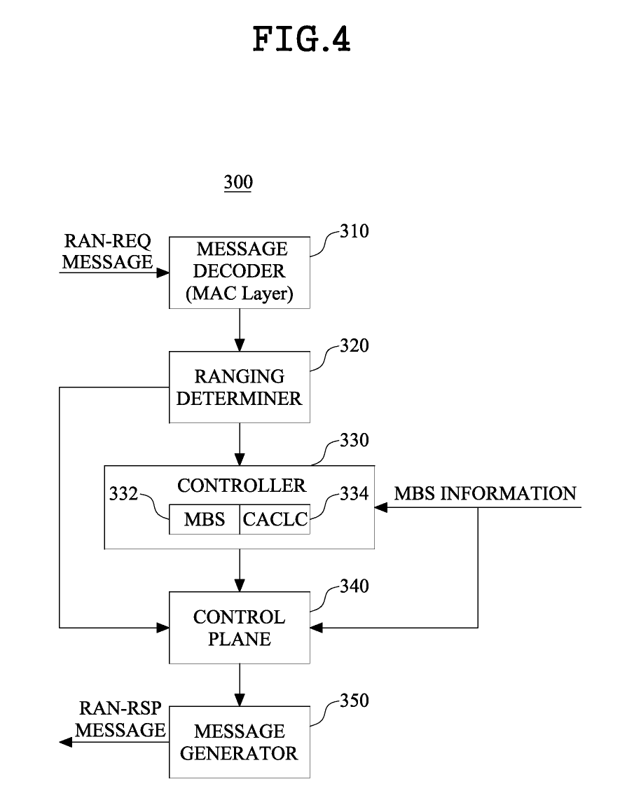

Therefore, the mobile station may receive MBS contents data from the base station and provide the MBS contents data to a user. Matters of the MBS information included in the ranging response (RNG-RSP) message will be described below with reference to FIG. 4.

Referring to FIG. 4, an MBS supporting apparatus 300 according to another embodiment of the present invention includes a message decoder 310, a ranging determiner 320, a controller 330, a control plane 340, and a message generator 350.

The message decoder 310 decodes a ranging request (RNG-REQ) message that is received from a mobile station via a receiver (not shown) of a base station.

The ranging determiner 320 checks an action state of the mobile station on the basis of information included in the ranging request (RNG-REQ) message.

Specifically, when an MBS indication bit is encoded into a ranging purpose indication TLV of the ranging request (RNG-REQ) message, the mobile station may be perceived as a mobile station having an MBS flow.

When a handover indication bit is encoded into the ranging purpose indication TLV and a serving BSID is included in the ranging request (RNG-REQ) message, it may be perceived that a mobile station is requiring ranging according to handover.

When the MBS indication bit and handover indication bit are encoded into the ranging purpose indication TLV and a paging controller ID is included in the ranging request (RNG-REQ) message, it may be perceived that a mobile station having the MBS flow is requiring ranging according to the change of the mobile station from the idle mode to the active mode.

When the MBS indication bit and a location update request bit are encoded into the ranging purpose indication TLV and the paging controller ID is included in the ranging request (RNG-REQ) message, it may be perceived that a mobile station having the MBS flow is requiring ranging which is performed when a paging group of the mobile station is changed in the idle mode.

Subsequently, the controller 330 includes an MBS control unit 332 and a CACLC control unit 334.

When the raging determination result from the ranging determiner 320 shows that the MBS indication bit is encoded into the ranging request (RNG-REQ) message received from a mobile station, the MBS control unit 332 determines MBS setting on the basis of the MBS information and supplies the determined matters for the MBS setting and the MBS information to the control plane 340.

The ranging request message including MBS indication may be applied to CACLC for estimating load that is applied to a base station according to the network entry of a mobile station, and determining whether to allow the provision of service to a subscriber.

The CACLC control unit 334 checks a current available wireless resource in ranging to determine whether to support service for a mobile station requiring ranging.

Specifically, when a current available wireless resource is insufficient, the CACLC control unit 334 may postpone the ranging of the mobile station requiring network entry, but when current available wireless resources are sufficient, the CACLC control unit 334 may allow the network entry of the mobile station. Herewith, the CACLC control unit 334 may determine whether to support service for the mobile station requiring ranging, in consideration of an MBS mobile station in ranging.

MBS allows a plurality of mobile stations located in the same cell to receive the same contents, and thus, load may be far less applied to a base station when a mobile station having an MBS flow enters a network additionally than when a non-MBS mobile station not supporting MBS enters the network.

Therefore, the CACLC control unit 334 separately performs CACLC in ranging according to an MBS mobile station and a non-MBS mobile station, and thus can decrease load that is applied to a base station according to the network entry of a mobile station.

For example, when a plurality of mobile stations require network entry, the CACLC control unit 334 cannot allow all the mobile stations to enter the network if a current available wireless resource is insufficient.

In the embodiment, when a current available wireless resource is insufficient, the CACLC control unit 334 preferentially allows the network entry of an MBS mobile station that applies relatively smaller load to a base station, in ranging.

By performing CACLC for the MBS mobile station with the MBS indication bit, the CACLC control unit 334 can accurately estimate additional load due to the network entry of a mobile station and more decrease load, applied to a base station, than when the non-MBS mobile station enters the network.

The control plane 340 sets an MBS parameter, on the basis of the MBS setting determination matters from the MBS control unit 332 and MBS information from an MCBSC server. Therefore, the control plane 340 enables a base station to support MBS to a mobile station having an MBS flow. Also, the control plane 340 sets a parameter for ranging according to an action state of the mobile station.

Herein, when an MBS zone of an MBS mobile station requiring ranging is changed, a multicast IP and an MCID are updated. The control plane 340 applies the CACLC result from the CACLC control unit 334 and supplies the MBS parameter setting information and CACLC result to the message generator 350.

In the above description, the ranging determiner 320 and controller 330 have been described as separate elements, but the embodiment is not limited thereto. As another example, the ranging determiner 320 and controller 330 may be integrated into the control plane 340.

The message generator 350 generates the ranging response (RNG-RSP) message in response to the ranging request (RNG-REQ) message received from a mobile station, in which case the message generator 350 may add MBS information into the ranging response (RNG-RSP) message in order to simplify a procedure for supporting MBS and a ranging procedure that is performed according to the network entry of an MBS mobile station.

In more detail, when a mobile station requiring ranging has an MBS flow, the message generator 350 may add MBS information (including a connection ID (CID) update TLV, a service flow ID (SFID), an MCID, an MBS zone ID, and an MBS contents ID) into the ranging response (RNG-RSP) message.

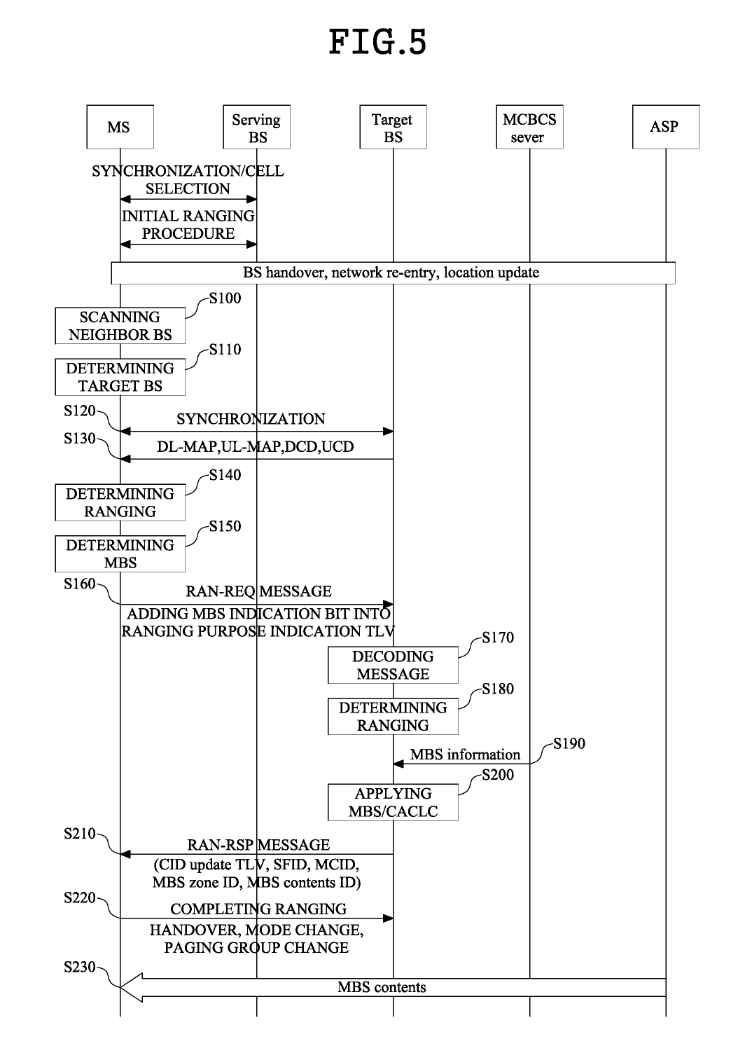

FIG. 5 is a diagram illustrating an MBS supporting method according to an embodiment of the present invention.

In FIG. 5, in an action state of a mobile station (MS) where the transmission of a ranging request (RNG-REQ) message is performed, the following description will be made on a case of handover, which is performed when the mobile station moves from a cell area of a service base station and enters a cell area of a base station adjacent thereto, as a main embodiment.

First, the mobile station is powered on, and performs cell selection and synchronization with a base station (serving base station) managing a cell where the mobile station is located. Subsequently, the mobile station receives a downlink-map (DL-MAP) message, uplink-map (UL-MAP) message, downlink channel descriptor (DCD) message, and uplink channel description (UCD) message from the serving base station to acquire a downlink (DL) sync parameter and an uplink (UL) transmission parameter.

Subsequently, the mobile station and the base station transmit/receive the ranging request (RNG-REQ) message and the ranging response (RNG-RSP) message therebetween to perform an initial network entry procedure.

If the mobile station moves from a cell area of the serving base station and enters a cell area of a base station (target base station) adjacent thereto, handover is performed.

The mobile station is required to select the target base station from among base stations adjacent thereto, for performing handover. For this end, the mobile station scans the adjacent base stations for handover in operation S100.

Subsequently, the mobile station checks all set frequency bands to detect a signal having the greatest signal intensity, namely, the greatest carrier to interference and noise ratio (CINR). The mobile station determines a base station of the adjacent base stations, which has transmitted a pilot channel signal having the greatest CINR, as the target base station in operation S110.

Afterward, the mobile station receives a preamble of a downlink (DL) frame from the target base station to acquire system synchronization with the target base station in operation S120.

Thereafter, the mobile station receives the DL-MAP message, UCD message, DCD message, and UL-MAP message from the target base station to acquire a downlink sync parameter and an uplink transmission parameter in operation S130.

Herein, the DCD message is a control message for transferring system information (which describes physical characteristic of the downlink channel) to the mobile station, and the UCD message is a control message for transferring system information (which describes physical characteristic of the uplink channel) to the mobile station.

The base station transmits the DCD message/UCD message through broadcast connection such that all mobile stations receiving service receive the DCD message/UCD message.

Subsequently, before generating a ranging request (RNG-REQ) message, ranging is determined by checking an action state of the mobile station requiring ranging in operation S140. Specifically, the mobile station determines whether ranging is performed according to the performance of handover, the change from the idle mode to the active, or the change of a paging group in the idle mode.

Afterward, the mobile station determines whether the mobile station has an MBS flow in operation S150.

Thereafter, the mobile station generates the ranging request (RNG-REQ) message according to the action state checked in operation S140 and the determined result for the MBS flow in operation S150, and transmits the generated ranging request (RNG-REQ) message to the base station through a transmitter thereof in operation S160.

Herein, the ranging request (RNG-REQ) message transmitted from the mobile station to the target base station may include information such as a downlink burst profile, an MAC address (MS MAC address), a preamble index, reception of a broadcast message in a mobile station (AAS broadcast capability), ranging anomalies, and an handover ID, in a TLV format.

After operation S160, when the target base station receives the ranging request (RNG-REQ) message including the ranging purpose indication TLV from the mobile station, the target base station decodes the received ranging request (RNG-REQ) message in operation S170.

The target base station may perceive that the mobile station has the MBS flow with an MBS indication bit of the ranging purpose indication TLV of the ranging request (RNG-REQ) message.

Moreover, the target base station determines ranging, required by the mobile station, with the ranging purpose indication TLV in operation S180. That is, the target base station may perceive an action state (handover, network re-entry, and location update) of the mobile station with a handover indication bit or a location update request bit.

Subsequently, when the MBS indication bit of the ranging purpose indication TLV is encoded, the target base station receives MBS information from an MCBCS server of a network in order for the mobile station to support MBS in operation S190.

At this point, the target base station sets a plurality of parameters for supporting MBS, on the basis of the MBS information received from the MCBCS server. Also, the target base station performs CACLC to check a current available wireless resource in operation S200. Herewith, when an MBS zone of an MBS mobile station requiring ranging is changed, the target base station may update a multicast IP and an MCID.

Herein, when current available wireless resources are sufficient as the CACLC result, the target base station may allow the mobile station to enter the network, but when the current available wireless resource is insufficient as the CACLC result, the target base station may postpone the network entry of the mobile station.

In this case, if the MBS indication bit has been encoded into the ranging purpose indication TLV, the target base station may preferentially apply CACLC to the MBS mobile station to change the network entry priority of a mobile station having the MBS flow.

Subsequently, the target base station generates the ranging response (RNG-RSP) message in response to the ranging request (RNG-REQ) message received from the mobile station, in which case the target base station may add MBS information into the ranging response (RNG-RSP) message in order to simplify a procedure for supporting MBS and a ranging procedure that is performed according to the network entry of the MBS mobile station.

Afterward, the target base station transmits the ranging response (RNG-RSP) message to the mobile station through a transmitter thereof in operation S210. Thereafter, the mobile station receives the ranging response (RNG-RSP) message from the target base station, and sets a plurality of MBS parameters on the basis of MBS information included in the ranging response (RNG-RSP) message.

Therefore, the mobile station completes the ranging procedure in operation S220. That is, the target base station adds MB S-related information into the ranging response (RNG-RSP) message transmitted to the mobile station and transmits the ranging response (RNG-RSP) message with the added information, thus simplifying the network entry procedure of the MBS mobile station. Subsequently, the mobile station receives MBS contents from an application service provider (ASP) and thus receives MBS in operation S230.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A device for supporting Multicast Broadcast Service (MBS) comprising:
a ranging determiner determining an action state of a mobile station according to a ranging request of the mobile station;
an MBS determiner determining whether the mobile station has an MBS flow; and
a message generator generating a ranging request message on the basis of the action state and MBS flow,
wherein when the mobile station has the MBS flow, the message generator adds an MBS indication bit, representing “the mobile station is an MBS mobile station”, into a ranging purpose indication TLV of the ranging request message.

2. The device for supporting MBS of claim 1, wherein when the action state is handover or a change from an idle mode to an active mode, the message generator further adds a handover indication bit into the ranging purpose indication TLV.

3. The device for supporting MBS of claim 1, wherein when the action state is handover, the message generator adds a serving base station ID into the ranging request message.

4. The device for supporting MBS of claim 1, wherein when the action state is that a mobile station having the MBS flow is changed from an idle mode to an active mode, the message generator adds a paging controller ID into the ranging request message.

5. The device for supporting MBS of claim 1, wherein when the action state is that a paging group of a mobile station having the MBS flow is changed in an idle mode, the message generator further adds a location update request bit into the ranging purpose indication TLV.

6. The device for supporting MBS of claim 5, wherein when location update, performed according to the change of the paging group, is initial location update or location update for MBS zone update, the message generator further adds a paging controller ID into the ranging request message.

7. The device for supporting MBS of claim 1, wherein,
in bit 0 to bit 8 of the ranging purpose indication TLV,
the message generator encodes the handover indication bit into the bit 0,
the message generator encodes the location update request bit into the bit 1, and
the message generator encodes the MBS indication bit into the bit 4.

8. The device for supporting MBS of claim 1, further comprising a control plane setting a parameter for applying MBS and ranging, on the basis of ranging information and MBS information which are comprised in a ranging response message.

9. A method for supporting Multicast Broadcast Service (MBS) comprising
determining an action state of a mobile station, and determining whether the mobile station has an MBS flow, when ranging is requested;
generating a ranging request message when the mobile station is determined as having the MBS flow, the ranging request message comprising: the action state of the mobile station; and an MBS indication bit representing “the mobile station is an MBS mobile station; and
transmitting the ranging request message to a base station.

10. The method for supporting MBS of claim 9, wherein when the action state is handover or a change from an idle mode to an active mode, a handover indication bit is further added into the ranging purpose indication TLV.

11. The method for supporting MBS of claim 9, wherein when the action state is handover, a serving base station ID is further added into the ranging request message.

12. The method for supporting MBS of claim 9, wherein when the action state is a change from an idle mode to an active mode, a paging controller ID is further added into the ranging request message.

13. The method for supporting MBS of claim 9, wherein when the action state is change of a paging group of an idle-mode mobile station, a location update request bit is further added into the ranging purpose indication TLV.

14. The method for supporting MBS of claim 13, wherein when location update, performed according to the change of the paging group, is initial location update or location update for MBS zone update, a paging controller ID is further added into the ranging request message.
